(19) United States
(12) Patent Application Publication
(10) Pub. No.: US 2017/0169367 A1
(43) Pub. Date: Jun. 15, 2017

(54) SYSTEM AND METHOD FOR DETERMINING EFFECTIVENESS OF REQUIREMENT GATHERING FOR A PROJECT

(71) Applicant: Wipro Limited, Bangalore (IN)

(72) Inventor: Ritu CHAKRABARTI, Bangalore (IN)

(73) Assignee: Wipro Limited

(21) Appl. No.: 15/007,372

(22) Filed: Jan. 27, 2016

(30) Foreign Application Priority Data
Dec. 14, 2015 (IN) 6693/CHE/2015

(51) Int. Cl. G06Q 10/06

(52) U.S. Cl. CPC G06Q 10/0631

(57) ABSTRACT

Certain embodiments of the present disclosure relate to a method for determining at least one level of effectiveness of requirement gathering for one or more projects. The method may comprise analyzing, context associated with the one or more projects using predefined qualifiers. The method may further comprise, determining nature of the one or more projects based on the outcome of the analyzing. Further the method may comprise dynamically assigning, one or more weightages to one or more parameters associated with the one or more projects. Furthermore, the method may comprise, capturing, predicted values and actual values of the one or more parameters and requirement gathering tool. In addition, the method may comprise, determining Effective Requirement Gathering Index (ERGI) based on a comparison between the predicted values, the actual values of each of the one or more parameter and the weightages of the one or more parameters.

### TECHNICAL FIELD

This disclosure relates generally to project management. More specifically, it relates to a system and method for determining effectiveness of requirement gathering for a project.

### BACKGROUND

It is a well-known fact that project management is firmly based on projecting, planning, organizing, motivating and controlling resources to achieve specific goals and meet specific business needs and demands. Any such project designed to produce a new product, service or result with a defined beginning and end undertaken to meet unique goals and objectives, resulting to bring any beneficial value in an organization.

There are basically three degrees of freedom in project management and they are schedule, scope and quality. These are termed as duration of the project, size of the project and critical to quality. Any analysis in project management includes these parameters mandatorily. Hence these parameters get selected as project qualifiers. Requirement Gathering is the key phase of any project. If the requirements are captured effectively, the project can easily achieve its goal. On the other hand, a poor requirement gathering can affect the project in terms of effort, schedule, customer satisfaction and cost. Some of the results have determined that requirement gathering is important for the project and any poor requirements gathering, analysis and management are directly responsible for 70 to 80% of project failures. Also, approximately 70%-85% of all project rework costs are due to errors in requirements. Thus there is a strong need to determine effectiveness of requirement gathering for any such projects.

### SUMMARY

Certain embodiments of the present disclosure relate to a method for determining at least one level of effectiveness of requirement gathering for one or more projects. The method may comprise analyzing, by a project management device, context associated with the one or more projects using predefined qualifiers. The method may further comprise, determining, by the project management device, nature of the one or more projects based on the outcome of the analysis. Further the method may comprise dynamically assigning, by the project management device, one or more weightages to one or more parameters associated with the one or more projects. Furthermore, the method may comprise, capturing, by the project management device, predicted values and actual values of the one or more parameters and requirement gathering tool. In addition, the method may comprise, determining, by the project management device, Effective Requirement Gathering Index (ERGI) based on a comparison between the predicted values, the actual values of each of the one or more parameters and the weightages of the one or more parameters. The method may comprise, determining, by the project management device, at least one level of effectiveness of requirement gathering based on the ERGI.

Certain embodiments of the present disclosure also relate to a project management device for determining at least one level of effectiveness of requirement gathering for one or more projects, comprising a processor, a memory communicatively coupled to the processor, wherein the memory stores processor-executable instructions, which, on execution, cause the processor to analyze context associated with the one or more projects using predefined qualifiers. Further, the processor, the memory communicatively coupled to the processor, wherein the memory stores processor-executable instructions, which, on execution, cause the processor to determine nature of the one or more projects based on the outcome of the analysis. Furthermore, the processor, the memory communicatively coupled to the processor, wherein the memory stores processor-executable instructions, which, on execution, cause the processor to dynamically assign one or more weightages to one or more parameters associated with the one or more projects. Moreover, the processor, the memory communicatively coupled to the processor, wherein the memory stores processor-executable instructions, which, on execution, cause the processor to capture predicted values and actual values of the one or more parameters and requirement gathering tool. In addition, the processor, the memory communicatively coupled to the processor, wherein the memory stores processor-executable instructions, which, on execution, cause the processor to determine Effective Requirement Gathering Index (ERGI) based on a comparison between the predicted values, the actual values of each of the one or more parameters and the weightages of the one or more parameters. Further, the processor, the memory communicatively coupled to the processor, wherein the memory stores processor-executable instructions, which, on execution, cause the processor to determine at least one level of effectiveness of requirement gathering based on the ERGI.

Certain embodiments of the present disclosure also relate to a non-transitory, computer-readable medium storing instructions that, when executed by a processor device, cause the processor device to perform operations comprising analyzing, by a project management device, context associated with the one or more projects using predefined qualifiers. Further, the computer-readable medium storing instructions that, when executed by a processor device, cause the processor device to perform operations comprising determining, by the project management device, nature of the one or more projects based on the outcome of the analysis. Furthermore, the computer-readable medium storing instructions that, when executed by a processor device, cause the processor device to perform operations comprising dynamically assigning, by the project management device, one or more weightages to one or more parameters associated with the one or more projects. In addition, the computer-readable medium storing instructions that, when executed by a processor device, cause the processor device to perform operations comprising capturing, by the project management device, predicted values and actual values of the one or more parameters and requirement gathering tool. Moreover, the computer-readable medium storing instructions that, when executed by a processor device, cause the processor device to perform operations comprising determining, by the project management device, Effective Requirement Gathering Index (ERGI) based on a comparison between the predicted values, the actual values of each of the one or more parameter and the weightages of the one or more parameters. Further, the computer-readable medium storing instructions that, when executed by a processor device, cause the processor device to perform operations comprising determining, by the project management device, at least one level of effectiveness of requirement gathering based on the ERGI.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 illustrates an exemplary overview of a system for determining at least one level of effectiveness of requirement gathering for one or more projects, according to some embodiments of the present disclosure;

FIG. 2 is a flowchart of an exemplary method for determining at least one level of effectiveness of requirement gathering for one or more projects, according to some embodiments of the present disclosure;

FIG. 3 is an exemplary screen shot of a table depicting a method for determining at least one level of effectiveness of requirement gathering for one or more projects, according to some embodiments of the present disclosure; and

FIG. 4 is yet another exemplary screen shot of another table depicting a method for determining at least one level of effectiveness of requirement gathering for one or more projects, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

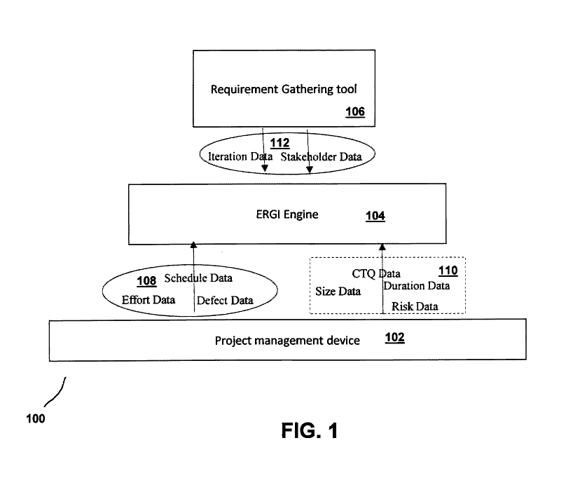

FIG. 1 illustrates an exemplary overview of a system 100 for determining at least one level of effectiveness of requirement gathering for one or more projects, according to some embodiments of the present disclosure.

The system 100 includes a project management device 102 in electronic communication with Effective Requirement Gathering Index (ERGI) engine 104. The ERGI engine 106 is further electronically in communication with requirement gathering tool 112.

The project management device 102 helps any project manager of any development team of an organization to plan and track a project. For example, efforts, schedule, cost, risk, matrices can be planned and monitored through this system. Typically, the software built in the project management device 102 has the capacity to help plan, organize, and manage resource tools and develop resource estimates. It can manage estimation and planning, scheduling, cost control and budget management, resource allocation, collaboration software, communication, decision-making, quality management and documentation. Globally recognized PC & browser based project management software are a well-known examples of project management device 102 to be accounted for. Further, the project management device 102 can be expected to provide information to various people or stakeholders, and can be used to measure and justify the level of effort required to complete the project(s). some of the features of the project management device 102 are listed below:

overview information on how long tasks will take to complete;

early warning of any risks to the project;

information on workload, for planning holidays;

evidence;

historical information on how projects have progressed;

how actual and planned performance are related;

optimum utilization of available resource;

cost maintenance;

collaboration with each teammates and customers; and

instant communication to collaborators and customers.

The requirement gathering tool 106 is used during requirement gathering phase to capture and maintain requirements. A database 112 depicts parameters like iteration data and stakeholder data for which the values are retrieved from requirement gathering tool 106. The tool for requirements management, improves quality by optimizing communication and collaboration, and by promoting compliance. Using advanced object-oriented techniques, requirement management tool makes it practical to produce structured and dynamic requirements documents. In the requirement gathering tool 106, requirements can be kept simple by clearly expressing them as a hierarchically organized set of text, pictures and tables. Some of the key features of the requirement gathering tool 106 are listed below:

a collaborative requirements management environment that allows all stakeholders to actively participate in the requirements process;

it has the ability to manage changing requirements;

a powerful life cycle traceability to help teams align their efforts with the business needs and measure the impact that changes will have on everything from business goals to development;

elevates informal requirements discussions;

scalability to address your requirements management needs; and

ability to exchange requirements data with other requirements management tools.

Some of the benefits of requirement gathering tool 106 are that it allows stakeholders to contribute new requirements, analyze or elaborate on existing requirements, and validate a specification directly from their Web browser; it enables development teams to create bi-directional traceability for impact analysis and traceability compliance; it keeps geographically distributed teams up to date with the latest project requirements information. It promotes collaboration among business users, marketing, suppliers, systems engineers and business analysts through requirements discussions. It provides fast and easy deployment to your user community; and it improves scalability by increasing the number of concurrent users on a single requirements repository.

The ERGI engine 104 helps in determining the ERGI metric. ERGI engine 104 receives parameter values from project management device 102 and requirement gathering tool 106. In some embodiments, the project management device 102, the requirement gathering tool 106 and the ERGI engine 104 are connected through business process management software that allows an organization to use a system of integrated applications to manage the business and automate many back office functions.

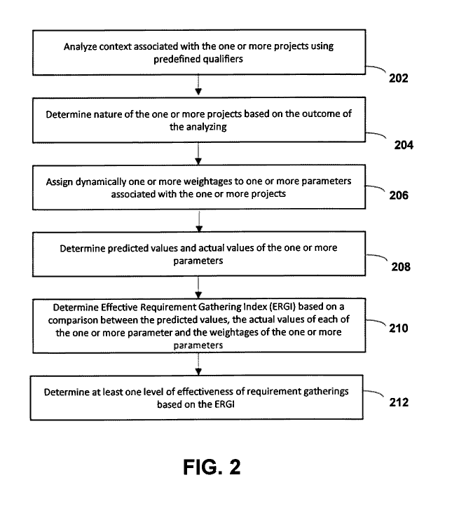

FIG. 2 is a flowchart of an exemplary method for determining at least one level of effectiveness of requirement gathering for one or more projects, according to some embodiments of the present disclosure.

At step 202, context associated with the one or more projects using predefined qualifiers is analyzed. In a project management environment, three main degrees of freedom to project development can be schedule, scope and quality. These can be further termed as duration of the project, size of the project, and critical to quality. Any analysis in project management environment includes these parameters mandatorily. The other important project management aspect is project governance. The roles relevant to requirement gathering are customer organization and business analyst. Hence these parameters get selected as qualifiers. Further, during the project execution requirement gathering becomes the first phase in the project. During which, the only one quality metric left having value will be a risk score. Hence the risk score gets considered as one such qualifier. Furthermore, the analysis is reflecting to determining certain parameters.

For example,

Requirement Gathering Effort Deviation<=Predicted value
Requirement Gathering Schedule Deviation<=Predicted value
Requirement Gathering Review Defects<=Predicted value
No. of Stakeholders involved in Requirement Gathering<=Planned value
No. of Iterations on the same business requirement in Requirement Gathering=1

At step 204, nature of the one or more projects based on the outcome of the analysis is determined. The combination of the above parameters varies from project to project. A few parameters are important for certain projects whereas, other set of parameters can be important for a different set of projects. Thus, nature of the one or more projects based on analysis is determined.

At step 206, one or more weightages to one or more parameters associated with the one or more projects are dynamically assigned.

For example, selection of parameters depends on the project context influenced by the qualifiers. The qualifiers values flow in from the project plan.

Below listed, are some of the qualifiers based on which the parameters are prioritized dynamically:

Risk score in the project—if the risk score is high indicating that it is a high risk project, then parameters related to effort, schedule and defect would get highest priorities;
Size of project—for large projects, the vital parameters would be related to effort, scheduled, and number of iterations;
Duration of the project—if the duration of the project is below six months, then second parameter i.e. schedule gets highest priority;
Critical To Quality (CTQ) of the project—if the CTQ of the project is cost effectiveness, then first parameter i.e. effort gets highest priority. If the CTQ is on time delivery, then second parameter i.e. schedule gets highest priority. If the CTQ is Post Delivery Defect Rate, then third parameter i.e. defect gets highest priority.
Business Analyst involvement—if Business Analyst is not involved in the project because of resource availability challenges, then the fifth parameter i.e. iteration gets highest priority.
Customer governance knowledge—if the team has not gathered customer governance information, then the forth parameter i.e. stakeholder involvement gets highest priority.

Hence, based on the evaluation of the project qualifiers, identification of the vital parameters takes place dynamically.

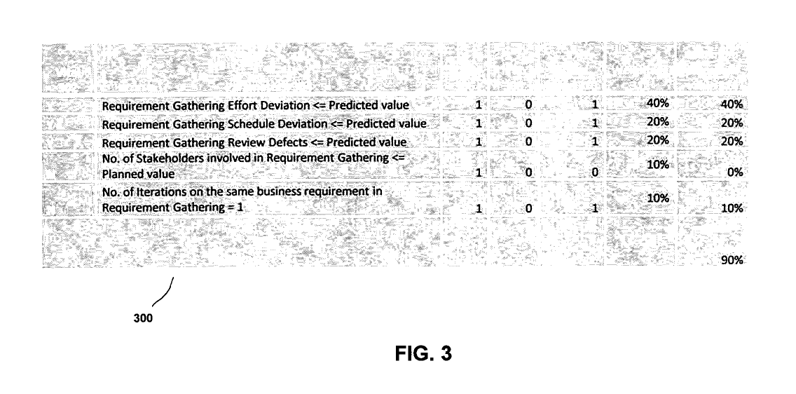

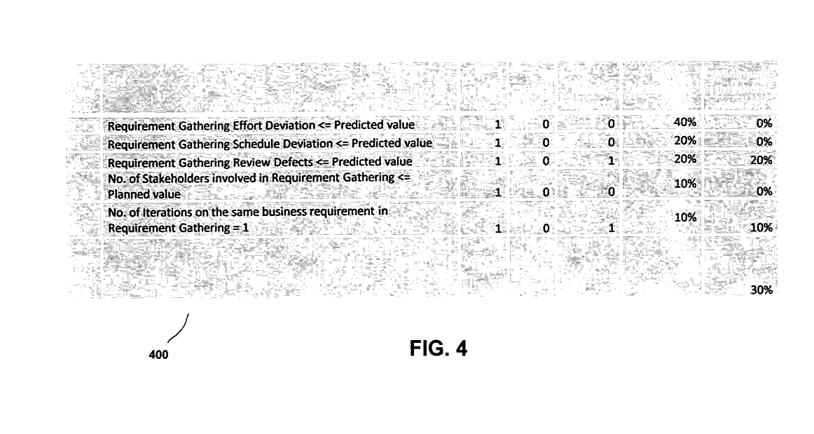

This is further well explained in conjunction with FIG. 3 and FIG. 4.

At step 208, predicted values and actual values of the one or more parameters and requirement gathering tool is captured. The values may be captured of the selected project parameters from a project plan of the project. Example, planned, predicted, actual effort, schedule, defects, number of stakeholders and number of iterations. Further, values of the defined parameters may be captured through various project management systems. Example, project management device 102 of the system 100.

At step 210, Effective Requirement Gathering Index (ERGI) based on a comparison between the predicted values, the actual values of each of the one or more parameter and the weightages of the one or more parameters is determined. For example, the ERGI is calculated based on the actual values for effort, schedule, defects, number of stakeholders, number of iterations flown from project management device 102 of the system 100. The effectiveness of requirement gathering is measured based on the ERGI value, the ranges being

Highly effective: ERGI value=>90%
Effective: 70%<=ERGI value<90%
Moderately effective: 50%<=ERGI value<70%
Not effective: ERGI value<50%.

At step 212, at least one level of effectiveness of requirement gathering based on the ERGI is determined. This is well explained in conjunction with FIG. 3 and FIG. 4.

FIG. 3 is an exemplary screen shot of a table 300 depicting a method for determining at least one level of effectiveness of requirement gathering for one or more projects, according to some embodiments of the present disclosure.

The table 300 includes a column vital 302, a column parameters 304, a column 306, a column 308, a column actual value 310, a column weightage 312 and a column minimum threshold value 314.

In the above case, the ERGI 316 results with 90%. Thus, based on the below chart:

Highly effective: ERGI value=>90%
Effective: 70%<=ERGI value<90%
Moderately effective: 50%<=ERGI value<70%
Not effective: ERGI value<50%.
the system 100 can conclude that requirement gathering is Highly Effective.

FIG. 4 is yet another exemplary screen shot of another table 400 depicting a method for determining at least one level of effectiveness of requirement gathering for one or more projects, according to some embodiments of the present disclosure.

The table 400 includes a column vital 402, a column parameters 404, a column 406, a column 408, a column actual value 410, a column weightage 412 and a column minimum threshold value 414.

In the above case, the ERGI 416 results with 30%. Thus, based on the below chart:

Highly effective: ERGI value=>90%
Effective: 70%<=ERGI value<90%
Moderately effective: 50%<=ERGI value<70%
Not effective: ERGI value<50%.
the system 100 can conclude that requirement gathering is Not Effective.

The specification has described system and method for determining effectiveness of requirement gathering for a project. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed:

1. A method for determining at least one level of effectiveness of requirement gathering for one or more projects, the method comprising:
analyzing, by a project management device, context associated with the one or more projects using predefined qualifiers;
determining, by the project management device, nature of the one or more projects based on the outcome of the analyzing;
dynamically assigning, by the project management device, one or more weightages to one or more parameters associated with the one or more projects;
capturing, by the project management device, predicted values and actual values of the one or more parameters and requirement gathering tool;
determining, by the project management device, Effective Requirement Gathering Index (ERGI) based on a comparison between the predicted values, the actual values of each of the one or more parameter and the weightages of the one or more parameters; and
determining, by the project management device, at least one level of effectiveness of requirement gathering based on the ERGI.

2. The method of claim 1, wherein the one or more qualifies are based on at least one of:
risk score;
size of the one or more projects;
duration of the one or more projects;
Critical To Quality (CTQ) of the one or more projects;
Business Analyst involvement; and
customer governance knowledge.

3. The method claim 1, wherein the one or more parameters are at least one of:
requirement gathering effort deviation;
requirement gathering schedule deviation;
requirement gathering review defects; and
number of stakeholders involved in the requirement gathering.

4. The method of claim 3 further comprises:
determining ERGI by determining the below
requirement gathering effort deviation<=predicted value 1;
requirement gathering schedule deviation<=predicted value 2;
requirement gathering review defects<=predicted value 3; and
number of stakeholders involved in the requirement gathering=1.

5. The method of claim 1, wherein the predefined qualifiers are stored in the project management device.

6. The method claim 1, further comprising:
planning efforts, schedule, cost, risk, matrices;
monitoring and tracking the one or more projects.

7. A project management device for determining at least one level of effectiveness of requirement gathering for one or more projects, comprising:
a processor;
a memory communicatively coupled to the processor, wherein the memory stores processor-executable instructions, which, on execution, cause the processor to
analyze context associated with the one or more projects using predefined qualifiers;
determine nature of the one or more projects based on the outcome of the analyzing;
dynamically assign one or more weightages to one or more parameters associated with the one or more projects;
capture predicted values and actual values of the one or more parameters and requirement gathering tool;
determine Effective Requirement Gathering Index (ERGI) based on a comparison between the predicted values, the actual values of each of the one or more parameter and the weightages of the one or more parameters; and
determine at least one level of effectiveness of requirement gathering based on the ERGI.

8. The project management device claim 7 further comprising:
planning efforts, schedule, cost, risk, matrices;
monitoring and tracking the one or more projects.

9. The project management device claim 7 further comprising:
a requirement gathering tool to capture and maintain requirements associated with the one or more projects.

10. The project management device claim 7 further comprising:
a ERGI business processing device for determining ERGI metric.

11. The project management device of claim 7, wherein the one or more qualifies are based on at least one of:
risk score;
size of the one or more projects;
duration of the one or more projects;
Critical To Quality (CTQ) of the one or more projects;
BA involvement; and
customer governance knowledge.

12. The project management device of claim 7, wherein the one or more parameters are at least
one of:
requirement gathering effort deviation;
requirement gathering schedule deviation;
requirement gathering review defects; and
number of stakeholders involved in the requirement gathering.

13. The project management device of claim 7 further comprises:
determining ERGI by determining the below
requirement gathering effort deviation<=predicted value 1;
requirement gathering schedule deviation<=predicted value 2;
requirement gathering review defects<=predicted value 3; and
number of stakeholders involved in the requirement gathering=1.

14. The project management device of claim 7, wherein the predefined qualifiers are stored in the project management device.

15. A non-transitory computer readable medium including instructions stored thereon that when processed by a processor cause project management device for determining at least one level of effectiveness of requirement gathering for one or more projects cases to perform acts of:
analyzing, by a project management device, context associated with the one or more projects using predefined qualifiers;
determining, by the project management device, nature of the one or more projects based on the outcome of the analyzing;
dynamically assigning, by the project management device, one or more weightages to one or more parameters associated with the one or more projects;
capturing, by the project management device, predicted values and actual values of the one or more parameters and requirement gathering tool;
determining, by the project management device, Effective Requirement Gathering Index (ERGI) based on a comparison between the predicted values, the actual values of each of the one or more parameter and the weightages of the one or more parameters; and
determining, by the project management device, at least one level of effectiveness of requirement gathering based on the ERGI.
